(19) United States
(12) Patent Application Publication
(10) Pub. No.: US 2025/0067217 A1
(43) Pub. Date: Feb. 27, 2025

(54) FUEL SYSTEMS FOR AIRCRAFT ENGINES

(71) Applicant: General Electric Company, Schenectady, NY (US)

(72) Inventors: David Justin Brady, Lynn, MA (US); Victor Moreno Patan, Queretaro (MX); Michael Joseph Murray, Wyoming, OH (US); William James Mailander, Lynn, MA (US)

(21) Appl. No.: 18/455,316

(22) Filed: Aug. 24, 2023

(51) Int. Cl. B64D 37/30; B64D 37/00; F02C 7/32; F02C 9/26; F02C 9/32

(52) U.S. Cl. CPC F02C 7/22; F02C 7/232; F02C 7/236; F02C 9/263; F02C 9/32

(57) ABSTRACT

A turbo engine for an aircraft includes a gas turbine engine having a fuel system to provide fuel to a combustion section. The fuel system includes a variable displacement pump driven by an accessory gearbox that is powered by a shaft of the gas turbine engine. The variable displacement pump has an inlet side and an outlet side. The variable displacement pump includes an actuator configured to adjust a discharge flow rate of the variable displacement pump. The fuel system also includes a fuel metering valve configured to receive pressurized fuel from the variable displacement pump and control a flow rate of the pressurized fuel to the combustion section. The fuel system further includes a bypass valve fluidly coupling the outlet side and the inlet side of the variable displacement pump to direct an excess portion of the pressurized fuel at the outlet side back to the inlet side.

### FIELD OF THE DISCLOSURE

The present disclosure relates generally to aircraft engines, and more particularly, to fuel systems for aircraft engines.

### BACKGROUND

Aircraft engines (e.g., turbofan engines, turboprop engines, etc.) include a gas turbine engine (sometimes referred to as an engine core) and a fuel system to provide a constant flow of fuel to a combustion section of the gas turbine engine. The fuel system includes one or more pumps that are driven by a drive shaft of the gas turbine engine. The pump(s) increase the pressure of the fuel to ensure a sufficient flow rate of fuel is available to the combustion section of the gas turbine engine.

### BRIEF DESCRIPTION OF THE DRAWINGS

A full and enabling disclosure of the presently described technology, including the best mode thereof, directed to one of ordinary skill in the art, is set forth in the specification, which makes reference to the appended FIGS., in which:

FIG. 1 is a schematic cross-sectional view of an example turbo engine for an aircraft in which examples disclosed herein can be implemented.

FIG. 2 is a schematic diagram of an example first fuel system that can be implemented on the example turbo engine of FIG. 1.

FIG. 3 is a schematic diagram of an example accessory gearbox driven by the example turbo engine of FIG. 1 and used to power an example boost pump and an example variable displacement pump of the first fuel system.

FIG. 4 is a schematic diagram of an example second fuel system that can be implemented on the example turbo engine of FIG. 1.

FIG. 5 is a schematic diagram of an example third fuel system that can be implemented on the example turbo engine of FIG. 1.

FIG. 6 is a schematic diagram of an example fourth fuel system that can be implemented on the example turbo engine of FIG. 1.

FIG. 7 is a schematic diagram of an example fifth fuel system that can be implemented on the example turbo engine of FIG. 1.

FIG. 8 is a schematic diagram of an example sixth fuel system that can be implemented on the example turbo engine of FIG. 1.

FIG. 9 is a flowchart representative of example machine readable instructions and/or example operations that may be executed, instantiated, and/or performed by example programmable circuitry to implement an example fuel system controller for operating any of the example fuel systems disclosed herein.

FIG. 10 is a block diagram of an example processing platform including programmable circuitry structured to execute, instantiate, and/or perform the example machine readable instructions and/or perform the example operations of FIG. 9 to implement the example fuel system controller.

The figures are not to scale. Instead, the thickness of regions may be enlarged in the drawings. In general, the same reference numbers will be used throughout the drawing(s) and accompanying written description to refer to the same or like parts.

### DETAILED DESCRIPTION

Reference now will be made in detail to examples or embodiments of the presently described technology, one or more examples of which are illustrated in the drawings. Each example or embodiment is provided by way of explanation of the presently described technology, not limitation of the presently described technology. In fact, it will be apparent to those skilled in the art that various modifications and variations can be made in the presently described technology without departing from the scope or spirit of the presently described technology. For instance, features illustrated or described as part of one example or embodiment can be used with another example or embodiment to yield a still further example or embodiment. Thus, it is intended that the presently described technology covers such modifications and variations as come within the scope of the appended claims and their equivalents.

The terms “upstream” and “downstream” refer to a relative location or direction with respect to fluid flow between an upstream location or source of fluid and a downstream location or end location of the fluid. For example, “upstream” refers to a location that is relatively closer to or in a direction that is toward the upstream location or source of fluid, whereas “downstream” refers to a location that is relatively closer to or in a direction toward the downstream location or end location of the fluid. As used herein, the terms “axial” and “longitudinal” both refer to a direction parallel to the centerline axis of a gas turbine engine (e.g., a turboprop, a core gas turbine engine, etc.), while “radial” refers to a direction perpendicular to the axial direction, and “tangential” or “circumferential” refers to a direction mutually perpendicular to the axial and radial directions. Accordingly, as used herein, “radially inward” refers to a relative location or direction along a radial line from the outer circumference of the gas turbine engine towards the centerline axis of the gas turbine engine, and “radially outward” refers to a relative location or direction along a radial line from the centerline axis of the gas turbine engine towards the outer circumference of the gas turbine engine.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A. (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Turbo engines (e.g., turbofan engines, turboprop engines, etc.), such as those used on aircraft, include a fuel system that supplies a constant flow of pressurized fuel to a combustion section of the engine. The fuel system typically includes a boost pump and a main pump arranged in series. The boost pump receives fuel from a fuel tank and increases the pressure of the fuel to a first pressure. The main pump receives the fuel from the boost pump and further increases the pressure to a higher, second pressure, which is then supplied through a metering valve to the combustion chamber of the engine. This high pressure fuel is also used as a hydraulic pressure source for various valves and actuators on the engine and/or the aircraft. The boost pump and the main pump are driven by an accessory gearbox that is powered by a high-pressure shaft of the turbo engine. Therefore, the boost pump and the main pump are in a fixed speed ratio with the turbo engine. In other words, the speeds of the boost pump and the main pump are directly related to the speed of the turbo engine.

Known fuel systems utilize a fixed displacement as the main pump. As such, the output of the main pump is directly related to the speed of the turbo engine. The main pump is typically sized and powered to produce fuel flow well above the pressure and flow demands of the turbo engine to ensure an adequate supply of fuel during operation. In other words, the main pump is typically oversized for most operating conditions. As such, in some operating conditions, the main pump overproduces pressurized fuel. Therefore, a portion of the pressurized fuel is circulated through a bypass valve back to the inlet side of the main pump. As a result, the bypassed portion of the discharge flow from the main pump is pressurized and depressurized but does no useful work and therefore the power extracted from the engine negatively impacts the overall engine efficiency. This also produces waste heat that increases the temperature of the fuel.

Fuel systems are designed to withstand a certain temperature. Higher temperature fuel can lacquer and form coke along the fuel lines and devices, which negatively affects the various fuel lines and devices (e.g., clogs the devices). Also, as mentioned above, some known systems include a recirculation flow back to the fuel tank. As such, the heated fuel is returned back to the fuel tank, which results in high fuel tank starting temperature. This degrades the fuel-oil thermal management system (FOTMS) and vehicle thermal management (VTMS) performance. Therefore, this increased heat during certain power modes is undesired. Some known systems attempt to address this problem by adding additional chillers or coolers to reduce the temperature of the fuel. These systems are expensive, complex, and add significant weight to the overall engine.

Disclosed herein are example fuel systems for aircraft turbo engines that include a variable displacement pump as the main pump of the fuel system. A variable displacement pump is a type of pump where the stroke of the pumping member can be changed. For example, the variable displacement pump may be implemented as a variable displacement vane pump or a variable displacement piston pump. This enables the discharge flow rate and/or pressure output to be changed independent of the input shaft speed. Therefore, the discharge flow rate and/or pressure output by the variable displacement pump be changed independent of the speed of the turbo engine. As such, the stroke of the variable displacement pump can be changed (e.g., reduced) to reduce (e.g., minimize) excess flow capacity at various operating conditions. For example, the variable displacement pump can be controlled to produce pressurized fuel at or closer to the demands of the combustion section and actuator devices. This reduces power consumption or draw from the engine. As such, the example fuel systems disclosed herein improve overall efficiency of the engine. Further, by reducing excess flow, the example fuel systems reduce (e.g., minimize) waste heat and thereby reduce or prevent lacquering and coke formation, and well as eliminate or reduce the need for chiller or coolers.

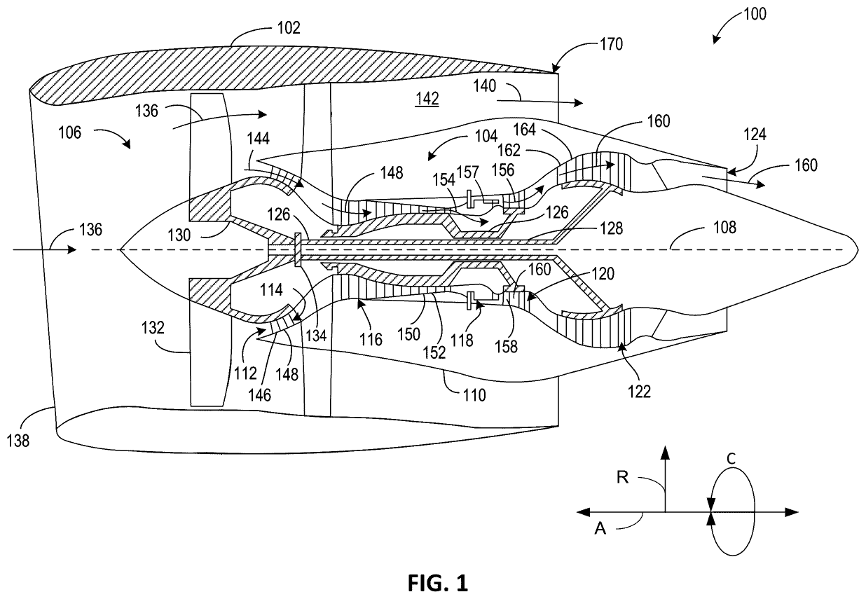

Referring now to the drawings, FIG. 1 is a schematic cross-sectional view of an example turbo engine 100 that can incorporate various examples disclosed herein. The example turbo engine 100 can be implemented on an aircraft and therefore referred to as an aircraft engine. In this example, the turbo engine 100 is a turbofan-type of engine. However, the principles of the present disclosure are also applicable to other types of engines, such as turboprop engines and engines without a nacelle, such as unducted fan (UDF) engines (sometimes referred to as propfans). Further, the example principles disclosed herein can be implemented on other types of engines, such as non-aircraft engines.

As shown in FIG. 1, the turbo engine 100 includes an outer bypass duct 102 (which may also be referred to as a nacelle, fan duct, or outer casing), a gas turbine engine 104 (which may also be referred to as a core turbine engine), and a fan section 106. The gas turbine engine 104 and the fan section 106 are disposed at least partially in the outer bypass duct 102. The gas turbine engine 104 is disposed downstream from the fan section 106 and drives the fan section 106 to produce forward thrust.

As shown in FIG. 1, the turbo engine 100 and/or the gas turbine engine 104 define a longitudinal or axial centerline axis 108 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108. Further, as used herein, the term “forward” refers to a direction along the centerline axis 108 in the direction of movement of the turbo engine 100, such as to the left in FIG. 1, while the term “rearward” refers to a direction along the centerline axis 108 in the opposite direction, such as to the right in FIG. 1.

The gas turbine engine 104 includes a substantially tubular outer casing 110 (which may also be referred to as a mid-casing) that defines an annular inlet 112. The outer casing 110 of the gas turbine engine 104 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118, a turbine section having a high pressure turbine 120 (“HP turbine 120”) and a low pressure turbine 122 (“LP turbine 122”), and an exhaust section 124.

The gas turbine engine 104 includes a high pressure shaft 126 (“HP shaft 126”) that drivingly couples the HP turbine 120 and the HP compressor 116. The gas turbine engine 104 also includes a low pressure shaft 128 (“LP shaft 128”) that drivingly couples the LP turbine 122 and the LP compressor 114. The LP shaft 128 also couples to a fan shaft 130.

The fan section 106 includes a plurality of fan blades 132 that are coupled to and extend radially outward from the fan shaft 130. In some examples, the LP shaft 128 may couple directly to the fan shaft 130 (i.e., a direct-drive configuration). In alternative configurations, the LP shaft 128 may couple to the fan shaft 130 via a reduction gear 134 (e.g., an indirect-drive or geared-drive configuration). While in this example the gas turbine engine 104 includes two compressor and two turbines, in other examples, the gas turbine engine 104 may only include one compressor and one turbine. Further, in other examples, the gas turbine engine 104 can include more than two compressors and turbines. In such examples, the gas turbine engine 104 may include more than two drive shafts or spools.

As illustrated in FIG. 1, during operation of the turbo engine 100, air 136 enters an inlet portion 138 of the turbo engine 100. The air 136 is accelerated by the fan blades 132 (sometimes considered a low-pressure compressor). A first portion 140 of the air 136 flows into a bypass airflow passage 142, while a second portion 144 of the air 136 flows into the inlet 112 of the gas turbine engine 104 (and, thus, into the LP compressor 114). One or more sequential stages of LP compressor stator vanes 146 and LP compressor rotor blades 148 coupled to the LP shaft 128 progressively compress the second portion 144 of the air 136 flowing through the LP compressor 114 en route to the HP compressor 116. Next, one or more sequential stages of HP compressor stator vanes 150 and HP compressor rotor vanes 152 coupled to the HP shaft 126 further compress the second portion 144 of the air 136 flowing through the HP compressor 116. This provides compressed air 154 to the combustion section 118 where it mixes with fuel and burns to provide combustion gases 156. Fuel is injected into the combustion section 118 by one or more nozzles 157. The turbo engine 100 includes a fuel system to provide pressurized fuel through the nozzles 157 to the combustion section 118 of the gas turbine engine 104. Example fuel systems are disclosed in further detail herein.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the fan shaft 130. The combustion gases 156 then exit the gas turbine engine 104 through the exhaust section 124 thereof. The combustion gases 156 mix with the first portion 140 of the air 136 from the bypass airflow passage 142. The combined gases exit an exhaust nozzle 170 (e.g., a converging/diverging nozzle) of the bypass airflow passage 142 to produce propulsive thrust.

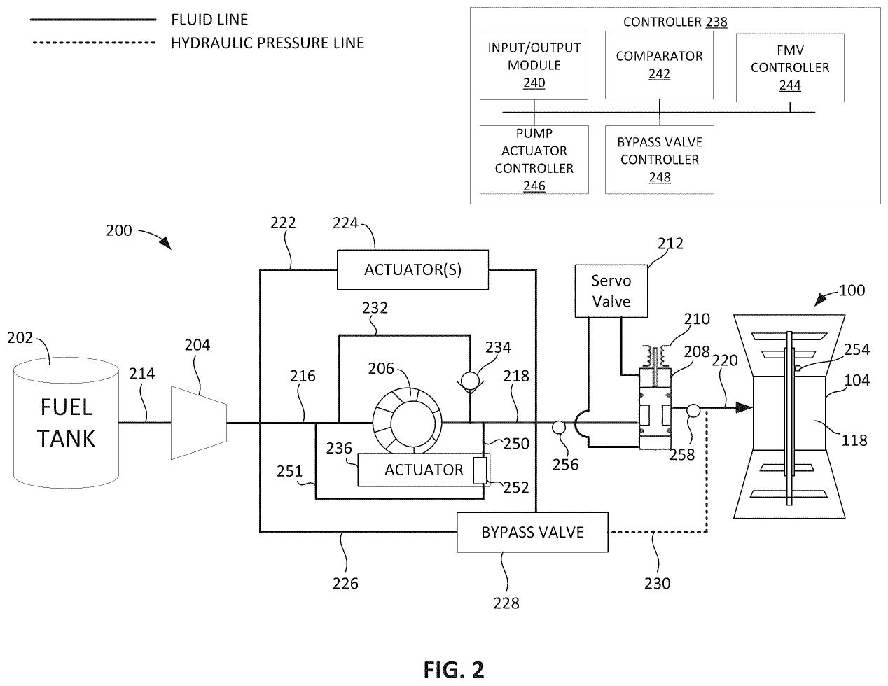

FIG. 2 is a schematic diagram of an example first fuel system 200 that can be implemented in connection with the example turbo engine 100 of FIG. 1. The first fuel system 200 is used to provide or supply fuel to the combustion section 118 of the gas turbine engine 104 and can also be used to support fuel to one or more other locations (e.g., devices, systems, etc.), as disclosed in further detail herein. In the schematic diagram of FIG. 2, solid lines represent fluid lines that enable fluid (e.g., fuel) to flow between two or more locations, whereas dotted lines represent hydraulic pressure lines in which fluid (e.g., fuel) may be present but does not necessarily flow. The fluid lines and hydraulic pressure lines can be implemented by any type of fluid connection, such as a hose, a tube, a connector, a port, a channel, and/or any other structure or opening that fluidly couples two or more components. Therefore, any two or more components with a solid line or a dotted line between them can be considered fluidly coupled.

In the illustrated example, the first fuel system 200 includes a fuel tank 202 that stores fuel (e.g., Jet A, Jet A1, kerosene, etc.). In some examples, the fuel tank 202 is located in one or both of the wings of the aircraft. In other examples the fuel tank 202 can be disposed in another location on the aircraft (e.g., in the fuselage).

In the illustrated example, the first fuel system 200 includes a boost pump 204 and a variable displacement pump 206 (e.g., a main pump) arranged in series. The boost pump 204 and the variable displacement pump 206 progressively or sequentially increase the pressure of the fuel to ensure a sufficient supply of fuel is available for the combustion section 118 of the turbo engine 100. The boost pump 204 and the variable displacement pump 206 are driven or powered by the gas turbine engine 104 of the turbo engine 100, as disclosed in further detail herein.

In the illustrated example, the first fuel system 200 includes a fuel metering valve (FMV) 208 between the variable displacement pump 206 and the combustion section 118. The FMV 208 receives pressurized fuel from the variable displacement pump 206. The FMV 208 controls a flow rate of the pressurized fuel to the combustion section 118. Therefore, the FMV 208 meters the flow of fuel to the gas turbine engine 104. In this example, the FMV 208 is implemented as a sliding spool valve. However, in other examples, the FMV 208 can be implemented by another type of valve (e.g., a rotating spool valve). In the illustrated example, the fuel metering valve 208 is monitored or controlled by a linear variable differential transformer (LVDT) 210 and a servo valve 212. The servo valve 212 is fluidly coupled to the FMV 208 and controls a flow of fluid to hydraulically operate the FMV 208. In other words, the position of the FMV 208 is controlled by the servo valve 212 (e.g., by controlling hydraulically fluid into/out of the FMV 208). The LVDT 210 provides feedback to a controller (e.g., the FMV controller 244) by measuring the position of the FMV 208.

As shown in FIG. 2, the first fuel system 200 includes a first fluid line 214 that fluidly couples the fuel tank 202 and the boost pump 204, a second fluid line 216 that fluidly couples the boost pump 204 and the variable displacement pump 206, a third fluid line 218 that fluidly couples the variable displacement pump 206 and the FMV 208, and a fourth fluid line 220 that fluidly couples the FMV 208 and the combustion section 118 of the gas turbine engine 104. The fluid lines 214-220 can include any number or configurations of fluid connections. The variable displacement pump 206 has an inlet side, which is receives fuel via the second fluid line 216, and an outlet side, which is coupled to and deliver fuels to the third fuel line 218.

In operation, the boost pump 204 receives fuel from the fuel tank 202 and increases the pressure of the fuel to a first pressure, sometimes referred to as priming pressure. The variable displacement pump 206 receives the fuel at the priming pressure from the boost pump 204 and further increases the pressure of the fuel to a desired or set pressure, which is above the pressure demanded by the gas turbine engine 104 and other devices to ensure an adequate flow of fuel is available. For example, the boost pump 204 may increase the pressure to 200 pounds-per-square-inch (psi) and the variable displacement pump 206 may further increase the pressure to 1000 psi. In some examples, the boost pump 204 and the variable displacement pump 206 are sized and geared to ensure an adequate supply of fuel is available based on a range of operating speeds. After the fuel is pressurized by the boost pump 204 and the variable displacement pump 206, the FMV 208 controls the flow of fuel to the combustion section 118. For example, the FMV 208 may reduce the flow rate and/or pressure to an amount that achieves the desired speed of the gas turbine engine 104.

As disclosed above, at least some of the pressurized fuel is directed to the gas turbine engine 104 of turbo engine 100 where it can be injected into the combustion section 118. Additionally, in some examples, some of the fuel can be used as a high-pressure fluid source for one or more devices. For example, as shown in FIG. 2, the first fuel system 200 includes a fifth fluid line 222 that fluidly couples the third fluid line 218 (at the outlet of the variable displacement pump 206) to one or more actuator(s) 224. The actuator(s) 224 can include, for example, an actuator for inlet guide vanes on the turbo engine 100 or a variable area exhaust on the turbo engine 100. The pressurized fuel acts as a hydraulic power source for operating these actuator(s) 224. Additionally or alternatively, the fuel can be used for other devices such as valves, solenoids, etc. The fuel is then routed by the fifth fluid line 222 to the second fluid line 216 at the inlet or lower pressure side of the variable displacement pump 206. As such, the fuel used by the actuator(s) 224 is recirculated back through the variable displacement pump 206.

As disclosed above, the variable displacement pump 206 produces pressure above the demands of the combustion section 118 and the actuator(s) 224 to ensure an adequate supply of fuel is constantly available. Therefore, in the illustrated example of FIG. 2, the first fuel system 200 includes a sixth fluid line 226 (which may also be referred to as a bypass fluid line) with a bypass valve 228 that fluidly couples the third fluid line 218 and the second fluid line 216. The bypass valve 228 fluidly couples an outlet side of the variable displacement pump 206 and an inlet side of the variable displacement pump 206. This enables the bypass valve 228 to direct an excess portion of the pressurized fuel at the outlet side of the variable displacement pump 206 back to the inlet side of the variable displacement pump 206. The bypass valve 228 controls the amount of fuel available for the combustion section 118 and the actuator 224. In some examples, the bypass valve 228 is configured to operate (e.g., control an amount of the pressurized fuel directed from the outlet side to the inlet side) based on a pressure differential across the FMV 208. For example, in the illustrated example of FIG. 2, the first fuel system 200 includes a hydraulic pressure line 230 (which may also be referred to as a sense line) that fluidly couples the bypass valve 228 and the fourth fluid line 220 (and, thus, the outlet side of the FMV 208). Therefore, the bypass valve is hydraulically connected to the fuel pressure on both sides of the FMV 208. The bypass valve 228 is configured to maintain a nominal or fixed pressure drop of fuel across the FMV 208. In other words, by controlling the flow of excess fuel through the bypass valve 228, the bypass valve 228 controls the amount of fuel available at the FMV 208. Therefore, as the FMV 208 changes flow rates, the bypass valve 228 operates (e.g., opens or closes) to adjust the flow rate of the portion of the fuel sent to the FMV 208. In some examples, the bypass valve 228 does not require any electrical actuation. Instead, the bypass valve 228 is hydromechanically controlled and automatically adjusts its position based on the pressure drop across the FMV 208. For example, the bypass valve 228 is fluidly coupled to pressures upstream and downstream of the FMV 208 (e.g., via the sixth fluid line 226 and the hydraulic pressure line 230). These pressures acting on areas of the FMV 208, as well as a spring force in the bypass valve 228, resolve as a force balance on a valve member (e.g., a sliding spool) in the bypass valve 228. The bypass valve 228 is configured to be in equilibrium at a fixed pressure differential (dP) across the FMV 208 (e.g., 30-100 psi drop/differential (psid)). Therefore, as the FMV 208 is stroked open/closed, the dP across the FMV 208 begins to change and stroke position of the bypass valve 228 automatically changes to achieve equilibrium. This changes the bypass flow rate through the sixth fluid line 226, which in turn achieves the setpoint flow through the FMV 208. However, in other examples, the bypass valve 228 may be an electronically controlled valve.

In the illustrated example of FIG. 2, the first fuel system 200 includes a seventh fluid line 232 with a relief valve 234 that fluidly couples the third fluid line 218 and the second fluid line 216. The relief valve 234 can be implemented as a one-way valve or check valve. The relief valve 234 is used as a back-up or redundant relief valve device. For instance, the relief valve 234 may be set to a relatively high pressure threshold (e.g., 2500 psi). Should the pressure at the outlet of the variable displacement pump 206 reach the threshold, the relief valve 234 opens to vent high pressure fluid back to the inlet of the variable displacement pump 206.

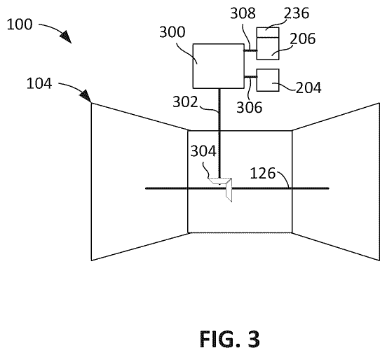

As disclosed above, the boost pump 204 and the variable displacement pump 206 are driven by the gas turbine engine 104 of the turbo engine 100. For example, referring to FIG. 3, the turbo engine 100 includes an accessory gearbox 300. The accessory gearbox 300 is driven or powered by a shaft 302, which is in gear with and driven by the HP shaft 126 of the gas turbine engine 104. For example, the shaft 302 may be in gear with the HP shaft 126 via bevel gears 304. Therefore, the accessory gearbox 300 is powered by the HP shaft 126 of the gas turbine engine 104. In other examples, the accessory gearbox 300 can be powered or driven by the LP shaft 128 of the gas turbine engine 104.

The accessory gearbox 300 may provide power to one or more devices. The accessory gearbox 300 may have one or more off-take shafts to drive the one or more accessories or devices, such as pumps, generators, etc. In this example, the boost pump 204 and the variable displacement pump 206 are driven by the accessory gearbox 300. For example, a first shaft 306 from the accessory gearbox 300 drives the boost pump 204 and a second shaft 308 from the accessory gearbox 300 drives the variable displacement pump 206. In other examples, the boost pump 204 and the variable displacement pump 206 can be driven by the same shaft from the accessory gearbox 300. The accessory gearbox 300 provides a fixed gear ratio between the gas turbine engine 104 and the boost and variable displacement pumps 204, 206. Therefore, the boost pump 204 and the variable displacement pump 206 are driven by the gas turbine engine 104.

The boost pump 204 may be driven at a fixed speed ratio with the turbo engine 100. As such, the speed of the turbo engine 100 directly affects the output rate and pressure of the boost pump 204. However, the pump 206 is implemented as a variable displacement pump. This means the displacement of a piston or other member of the variable displacement pump 206 can be changed, thereby affecting (e.g., increasing or decrease) the discharge flow rate and/or pressure of the variable displacement pump 206. As shown in FIGS. 2 and 3, the variable displacement pump 206 includes an actuator 236 (which may also be referred to as a pump actuator). The actuator 236 is used to adjust a discharge flow rate and/or pressure of the variable displacement pump 206. In particular, the actuator 236 can be activated to change the displacement of the piston or other member in the variable displacement pump 206. As such, while the variable displacement pump 206 is still mechanically driven by the gas turbine engine 104, the output flow rate and/or pressure of the variable displacement pump 206 can be changed independent of the speed of the gas turbine engine 104. In some examples, the variable displacement pump 206 is implemented as a variable displacement vane pump or a variable displacement piston pump. In other examples, the variable displacement pump 206 can be implemented as another type of variable displacement pump.

Using a variable displacement pump has many advantages. For example, the discharge flow rate and/or pressure of the variable displacement pump 206 can be controlled to reduce (e.g., minimize) excess fuel flow through the bypass valve 228. Therefore, the variable displacement pump 206 is not constantly overproducing fuel flow as seen in known fuel systems with fixed displacement pumps. This also reduces (e.g., minimizes) power draw off the gas turbine engine 104 and, thus, improves efficiency of the turbo engine 100. This also reduces (e.g., minimizes) temperature increases of the fuel and helps improve heat sync capability. As such, use of the first fuel system 200 eliminates or reduces the need for chillers or coolers as seen in known systems. For example, smaller air/oil heat exchangers can be used, which reduces weight of the overall system. The actuator 236 may control the discharge flow rate and/or pressure of the variable displacement pump 206 based on or more parameters and/or commands. For instance, in some examples, the actuator 236 is configured to adjust the discharge flow rate and/or pressure of the variable displacement pump based on an outlet pressure of the FMV. In other examples, the actuator 236 may adjust the discharge flow rate and/or pressure based on one or more other parameters (e.g., temperature, speed, etc.).

While in this example the boost pump 204 is driven by the gas turbine engine 104 via the accessory gearbox 300, in other examples, the boost pump 204 can be driven by an electric motor or other device. The boost pump 204 is located upstream of the variable displacement pump 206. In some examples, the first fuel system 200 may include more than one pump upstream to the variable displacement pump 206. In other examples, the first fuel system 200 may not include a boost pump. Instead, the first fuel system 200 may only include the variable displacement pump 206.

In the illustrated example of FIG. 2, the first fuel system 200 includes a controller 238 (e.g., a fuel system controller) to operate the various devices and control the operation of the first fuel system 200. The controller 238 is communicatively coupled to one or more sensors (disclosed in further detail below), the actuator 236 of the variable displacement pump 206, the valves 212, 228 and/or any other device that controls and/or monitors various parameters of the first fuel system 200. The controller 238 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the controller 238 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the controller 238 includes an input/output module 240, a comparator 242, a FMV controller 244, a pump actuator controller 246, and a bypass valve controller 248. The input/output module 240 receives signals from one or more sensors that measure one or more parameters or parameter values of the first fuel system 200 and/or the gas turbine engine 104. The comparator 242 compares the measured values of the parameter(s) to one or more thresholds or threshold ranges. Based on whether the parameter(s) satisfy the thresholds or threshold ranges, the controllers 244, 246, 248 can operate one or more of the devices to control the fuel pressurization and/or flow rates. The input/output module 240 can also receive signals or commands from other devices, such as pilot commands.

The FMV controller 244 controls the FMV 208. In particular, the FMV controller 244 controls the servo valve 212, which controls the position of the FMV 208 to affect the flow rate of fuel to the gas turbine engine 104. The FMV controller 244 receives feedback measurements from the LVDT 210. The FMV controller 244 may control the servo valve 212 based on one or more signals from the pilot, such as from a thrust or throttle lever in the cockpit. For example, based on the position of the thrust lever, the FMV 208 operates to supply more or less fuel to the combustion section 118 to achieve the desired level of thrust.

The pump actuator controller 246 controls the actuator 236 to affect the stroke of the variable displacement pump 206, and thereby affect the discharge flow rate and/or pressure of the variable displacement pump 206. In some examples, the pump actuator controller 246 is implemented by or in communication with a Full Authority Digital Engine Control (FADEC), sometimes referred to as an engine control unit or electronic engine controller. The FADEC determines or sets a target pump flow discharge rate and/or pressure, and the pump actuator controller 246 operates the actuator 236 to set the variable displacement pump 206 to achieve or meet the target pump flow discharge rate. In some examples, the actuator 236 is a hydraulically powered actuator. For example, the actuator 236 can be powered by pressurized fuel. For example, as shown in FIG. 2, an eighth fluid line 250 fluidly connects (e.g., ports) high pressure fluid from the third fluid line 218 to the actuator 236, and a ninth fluid line 251 fluidly connects lower pressure fluid from second fluid line 216 to the actuator 236. In particular, in this example, the actuator 236 includes a servo valve 252, which is fluidly coupled, via the eighth fluid line 250, to the outlet side of the variable displacement pump 206, and the ninth fluid line 251, to the inlet side of the variable displacement. The actuator 236 and the servo valve 252 operate based on the differential pressured on the inlet and outlet sides of the variable displacement pump 206. For example, the pump actuator controller 246 operates the servo valve 252 to control a flow the pressurized fuel (output by the variable displacement pump 206) into the actuator 236 and control the position of the actuator 236. In other examples, the actuator 236 can be an electrically powered actuator. For example, the actuator 236 may include an electric motor or solenoid that operates to control the position of the actuator 236. Therefore, in some examples, the pump actuator controller 246 can operate the actuator 236 by controlling a voltage applied to the actuator 236.

As disclosed above, the first fuel system 200 can include one or more sensors (e.g., pressure sensors, flow sensors, temperature sensors, speed sensors, etc.) to measure and/or monitor one or more parameters of the first fuel system 200 and/or the gas turbine engine 104. The pump actuator controller 246 may control the actuator 236 based on one or more of the measured parameter(s). In some examples, the comparator 242 compares the parameter(s) to one or more thresholds. If a parameter satisfies (e.g., exceeds) a threshold, for example, the pump actuator controller 246 may activate the actuator 236 to change (e.g., increase or decrease) the discharge rate of the variable displacement pump.

For example, the parameter may include a speed of the gas turbine engine 104. As shown in FIG. 2, the first fuel system 200 includes a speed sensor 254 for measuring the speed of the gas turbine engine 104. The speed may correspond to a speed of the LP shaft 128 (FIG. 1) or the HP shaft 126 (FIG. 1). The input/output module 240 receives speed measurements from the speed sensor 254, and the comparator 242 may compare the speed to one or more speed thresholds or ranges. Depending on the speed of the gas turbine engine 104, the pump actuator controller 246 controls the actuator 236 to change the stroke of the variable displacement pump 206, thereby changing the flow discharge rate and/or pressure.

As another example, the parameter may include a pressure or pressure differential at one or more locations of the first fuel system 200. For example, the first fuel system 200 of FIG. 2 includes sensors 256, 258 at the inlet and outlet of the FMV 208. The sensors 256, 258 may be pressure sensors. The comparator 242 may compare the pressure(s) and/or pressure differential to one or more thresholds or threshold ranges. Based on the comparison, the pump actuator controller 246 can control the actuator 236 to change the stroke of the variable displacement pump 206. As another example, the parameter may include a temperature of the fuel at one or more locations of the first fuel system 200. For example, the sensors 254, 256 may be temperature sensors. The pump actuator controller 246 may control the actuator 236 to change the discharge rate and/or pressure of the variable displacement pump 206 based on the temperature(s) and/or temperature differential. The first fuel system 200 can include more or fewer sensors and/or the sensors can be placed in other locations and/or measure other parameters. In some examples, the controller 238 can measure or monitor multiple parameters at the same time. The controller 238 may utilize one or more of these parameters to determine how to adjust the discharge rate and/or pressure of the variable displacement pump.

In some examples, the bypass valve 228 is an electronically controlled valve. In such example, the bypass valve controller 248 can control the state of the valve. For instance, the bypass valve 228 can be operated between an open state and a closed state (and/or any state therebetween (e.g., half open)). The bypass valve controller 248 may control the bypass valve 228 based on one or more sensor parameters (e.g., pressure, temperature, etc.) and/or signals from other devices (e.g., control devices in the cockpit). For example, the bypass valve controller 248 may operate the bypass valve 228 based on a pressure differential (e.g., measured by the sensors 256, 258) across the FMV 208.

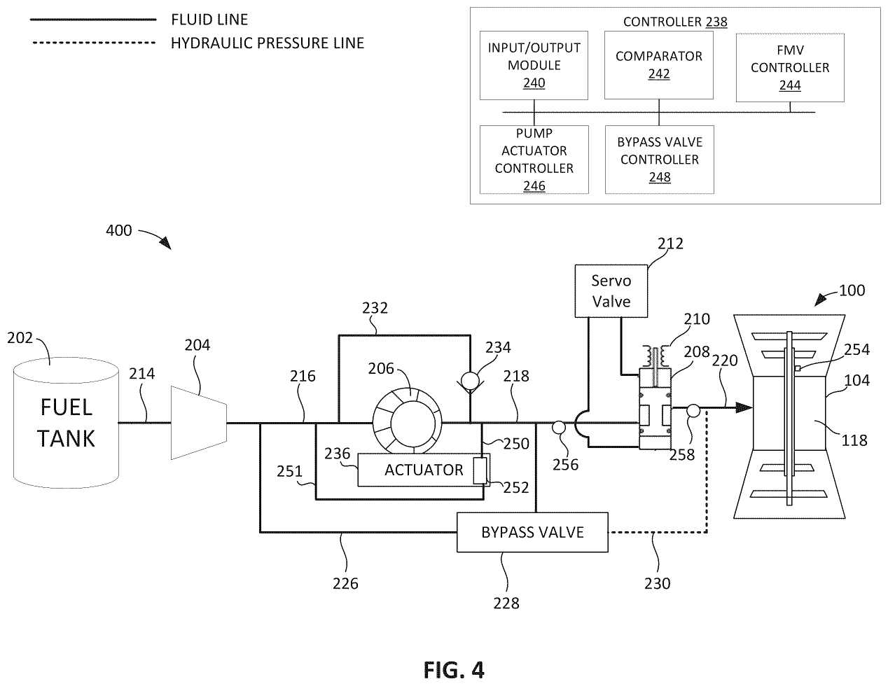

FIG. 4 is a schematic diagram of an example second fuel system 400 that can be implemented in connection with the turbo engine 100. Those components of the second fuel system 400 that are substantially similar or identical to the components of the first fuel system 200 disclosed above in connection with FIG. 2 and that have structure and/or functions substantially similar or identical to the structure and/or functions of those components will not be described in detail again below. Instead, the interested reader is referred to the above corresponding descriptions. To facilitate this process, the same reference numbers are used for like structures.

The second fuel system 400 of FIG. 4 has similar components and functionality as the first fuel system 200 of FIG. 2. However, in the second fuel system 400 of FIG. 4, the sixth fluid line 226 (FIG. 2) and the actuator(s) 224 (FIG. 2) have been removed. Therefore, in this example, the second fuel system 400 does not provide pressurized fuel to those additional actuators or devices. In this example, the pressurized fuel produced by the variable displacement pump 206 is directed only to the combustion section 118 and/or the bypass valve 228 (and/or the relief valve 234 in the event of over-pressurization). The controller 238 can operate substantially the same as disclosed in connection with the first fuel system 200 to operate the devices of the second fuel system 400 and control the flow rate and/or pressure of the fuel.

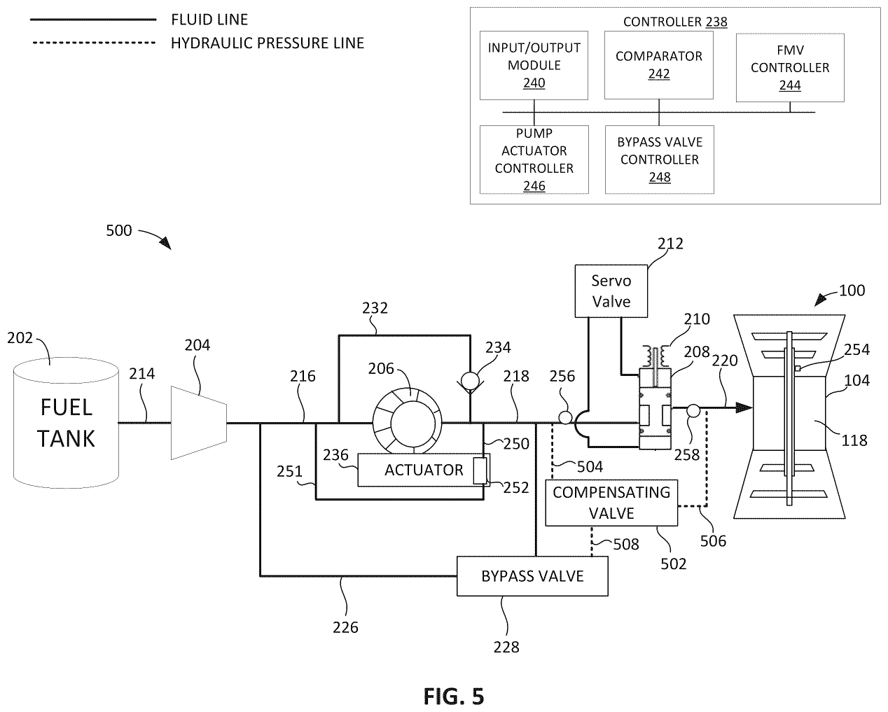

FIG. 5 is schematic diagram of an example third fuel system 500 that can be implemented in connection with the turbo engine 100. Those components of the third fuel system 500 that are substantially similar or identical to the components of the first fuel system 200 and/or the second fuel system 400 disclosed above in connection with FIGS. 2 and 4 and that have structure and/or functions substantially similar or identical to the structure and/or functions of those components will not be described in detail again below. Instead, the interested reader is referred to the above corresponding descriptions. To facilitate this process, the same reference numbers are used for like structures.

The third fuel system 500 of FIG. 5 includes a compensating valve 502, which is used to improve the accuracy of the position of the bypass valve 228 and thereby improve the metered accuracy of the fuel flow through the FMV 208. In general, the bypass valve 228 is configured to maintain a fixed pressure drop (e.g., 30-100 psid) across the FMV 208. The bypass valve 228 may be a traditional valve that includes a flow control member (e.g., a plug, a piston, a rotary sleeve, a plate, etc.). The flow control member is moved to certain positions to adjust the flow through the bypass valve 228, which affects the pressure drop across the FMV 208, to maintain the fixed pressure drop across the FMV 208. However, movement of the flow control member is not perfect and can be affected by the size of the valve and/or the spring rate. Therefore, the compensating valve 502 helps to fine tune the bypass valve position and improve the steady state accuracy of the FMV 208.

For example, as shown in FIG. 5, the third fuel system 500 includes a first hydraulic pressure line 504 that fluidly couples the third fluid line 218 and the compensating valve 502, and a second hydraulic pressure line 506 that fluidly couples the fourth fluid line 220 and the compensating valve 502. As such, the compensating valve 502 can sense or measure the pressure differential across the FMV 208. The third fuel system 500 includes a third hydraulic pressure line 508 that fluidly couples the compensating valve 502 and the bypass valve 228. Based on the pressure differential across the FMV 208, the compensating valve 502 can adjust the pressure in the third hydraulic pressure line 508, which adjusts a force margin on the bypass valve 228. This improves the accuracy of the metering system by compensating for pressure droop across the bypass valve 228. In particular, the ability of the bypass valve 228 to maintain a fixed dP across the FMV 208 is influenced factors such as fluid temperature, spring linearity, and manufacturing tolerance. Therefore, the compensating valve 502 improves the variation around the nominal pressure value, by accounting for these factors, so that the metered fuel out to the combustion section 118 is more accurate.

The controller 238 can operate substantially the same as disclosed in connection with the first fuel system 200 to operate the devices of the third fuel system 500 and control the flow rate and/or pressure of the fuel. In FIG. 5, the third fuel system 500 does not provide pressurized fuel to the actuator(s) 224 (FIG. 2). However, in other examples, the third fuel system 500 can provide pressurized fuel to the actuator(s) 224 similar to the first fuel system 200 in FIG. 2.

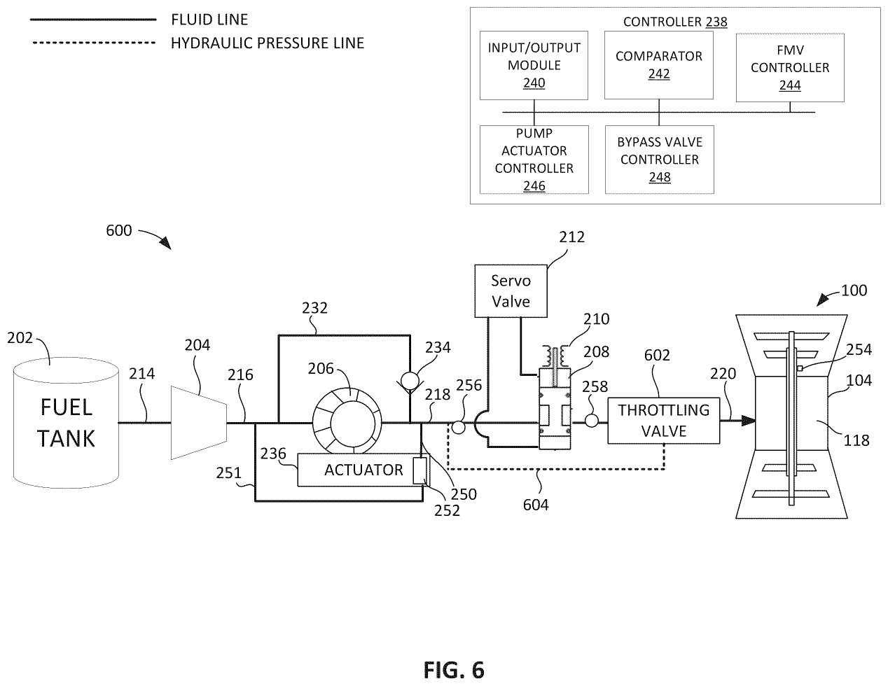

FIG. 6 is a schematic diagram of an example fourth fuel system 600 that can be implemented in connection with the turbo engine 100. Those components of the fourth fuel system 600 that are substantially similar or identical to the components of the first fuel system 200, the second fuel system 400, and/or the third fuel system 500 disclosed above in connection with FIGS. 2, 4, and 5 and that have structure and/or functions substantially similar or identical to the structure and/or functions of those components will not be described in detail again below. Instead, the interested reader is referred to the above corresponding descriptions. To facilitate this process, the same reference numbers are used for like structures.

In the illustrated example of FIG. 6, the fourth fuel system 600 does not include a bypass valve as in the fuel systems 200, 400, 500 of FIGS. 2, 4, and 5. Instead, as shown in FIG. 6, the fourth fuel system 600 includes a throttling valve 602. The throttling valve 602 is coupled to and/or otherwise integrated with the fourth fluid line 220. As such, the throttling valve 602 is fluidly coupled between the FMV 208 and the combustion section 118 of the gas turbine engine 104. The throttling valve 602 operates to reduce the pressure of the fuel prior to the combustion section 118 and maintain a fixed pressure drop across the FMV 208. For example, the fourth fuel system 600 includes a hydraulic pressure line 604 that fluidly couples the throttling valve 602 and the third fluid line 218 (and, thus, the inlet side of the FMV 208). As such, the throttling valve 602 can sense or measure the pressure differential across the FMV 208. The throttling valve 602 is configured to operate (e.g., adjust itself, open, close, move to a position between open and closed) based on the pressure differential across the FMV 208 to maintain a fixed pressure drop across the FMV 208. In other words, the throttling valve 602 can be adjusted to absorb whatever pressure difference is left over from the system. In some examples, the throttling valve 602 is implemented as a sliding spool valve. However, in other examples, the throttling valve 602 can be implemented by other types of valves. In some examples, similar to the bypass valve 228 (FIG. 2), the throttling valve 602 is hydraulically mechanically operated and automatically adjusts its position based on the dP across the FMV 208. In other examples, the throttling valve 602 is electrically operated, such as by the bypass valve controller 248. In some examples, the bypass valve controller 248 can control the throttling valve 602 based on one or more parameters (e.g., measured dP across the FMV 208).

The controller 238 can operate substantially the same as disclosed in connection with the first fuel system 200 to operate the devices of the fourth fuel system 600 and control the flow rate and/or pressure of the fuel. In FIG. 6, the fourth fuel system 600 does not provide pressurized fuel to the actuator(s) 224 (FIG. 2). However, in other examples, the fourth fuel system 600 can provide pressurized fuel the actuator(s) 224 similar to the first fuel system 200 in FIG. 2.

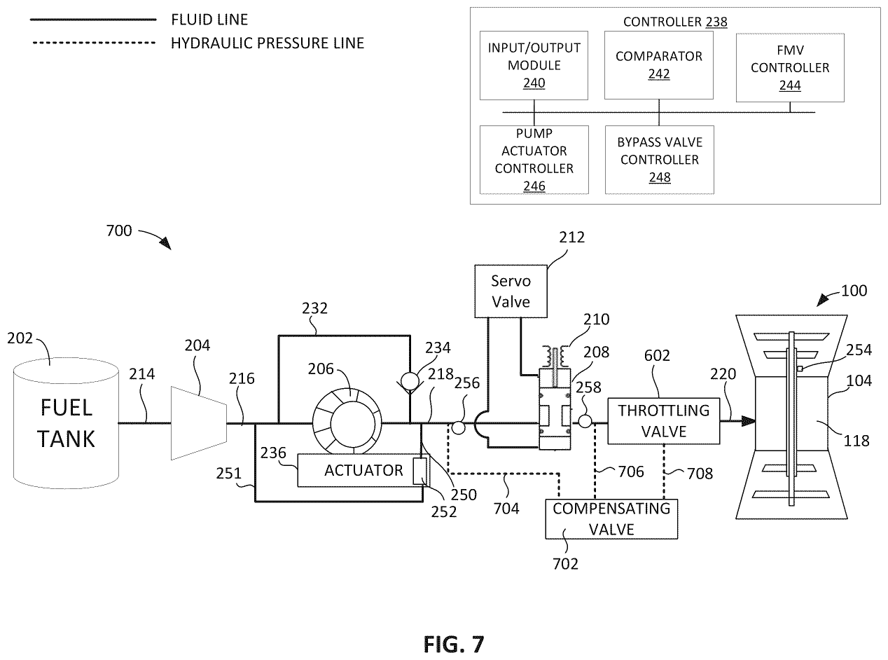

FIG. 7 is a schematic diagram of an example fifth fuel system 700 that can be implemented in connection with the turbo engine 100. Those components of the fifth fuel system 700 that are substantially similar or identical to the components of the first fuel system 200, the second fuel system 400, the third fuel system 500, and/or the fourth fuel system 600 disclosed above in connection with FIGS. 2, 4, 5, and 6 and that have structure and/or functions substantially similar or identical to the structure and/or functions of those components will not be described in detail again below. Instead, the interested reader is referred to the above corresponding descriptions. To facilitate this process, the same reference numbers are used for like structures.

The fifth fuel system 700 of FIG. 7 is similar to the fourth fuel system 600 of FIG. 6 but also includes a compensating valve 702. The compensating valve 702 operates similar to the compensating valve 502 of FIG. 5 to improve the metered accuracy of the fuel flow through the FMV 208. For example, as shown in FIG. 7, the fifth fuel system 700 includes a first hydraulic pressure line 704 that fluidly couples the third fluid line 218 and the compensating valve 702, and a second hydraulic pressure line 706 that fluidly couples between the fourth fluid line 220 and the compensating valve 702. As such, the compensating valve 702 can sense or measure the pressure differential across the FMV 208. The fifth fuel system 700 includes a third hydraulic pressure line 708 that fluidly couples the compensating valve 702 and the throttling valve 602. Based on the pressure differential across the FMV 208, the compensating valve 702 can adjust the pressure in the third hydraulic pressure line 708, which adjusts a force margin on the throttling valve 602. This compensation based on the pressure differential improves the accuracy of the metering system by compensating for pressure droop across the throttling valve 602. Therefore, the compensating valve 702 improves the variation around the nominal pressure value so that the metered fuel out to the combustion section 118 is more accurate.

The controller 238 can operate substantially the same as disclosed in connection with the first fuel system 200 to operate the devices of the fifth fuel system 700 and control the flow rate and/or pressure of the fuel. In FIG. 7, the fifth fuel system 700 does not provide pressurized fuel to the actuator(s) 224 (FIG. 2). However, in other examples, the fifth fuel system 700 can provide pressurized fuel to the actuator(s) 224 similar to the first fuel system 200 in FIG. 2.

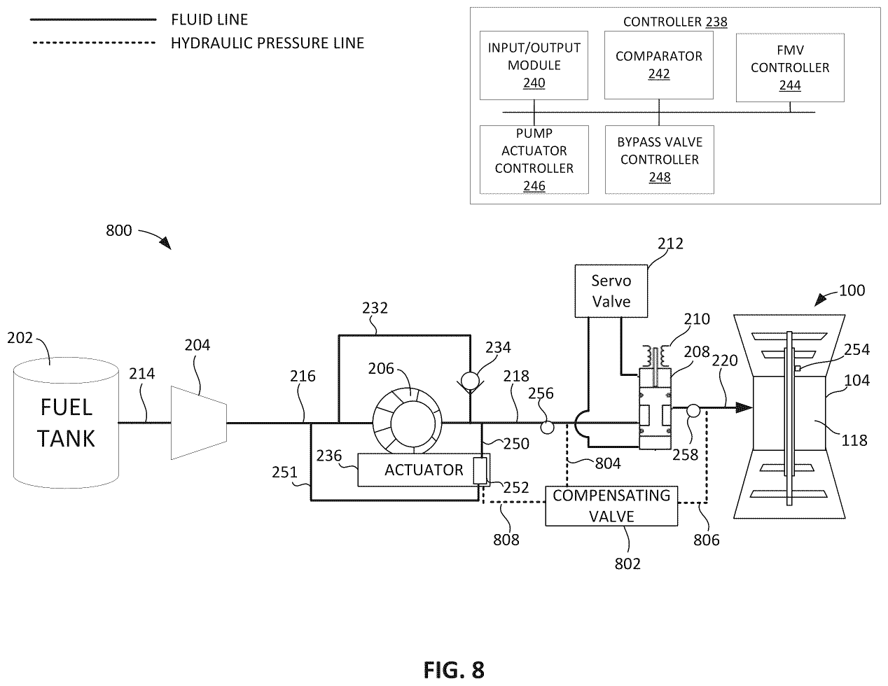

FIG. 8 is a schematic diagram of an example sixth fuel system 800 that can be implemented in connection with the turbo engine 100. Those components of the sixth fuel system 800 that are substantially similar or identical to the components of the first fuel system 200, the second fuel system 400, the third fuel system 500, the fourth fuel system 600, and/or the fifth fuel system 700 disclosed above in connection with FIGS. 2, 4, 5, 6, and 7 and that have structure and/or functions substantially similar or identical to the structure and/or functions of those components will not be described in detail again below. Instead, the interested reader is referred to the above corresponding descriptions. To facilitate this process, the same reference numbers are used for like structures.

The sixth fuel system 800 of FIG. 8 does not include a bypass valve or a throttling valve like in the fuel systems 200, 400, 500, 600, 700 of FIGS. 2, 4, 5, 6, and 7. The sixth fuel system 800 of FIG. 8 includes a compensating valve 802. The compensating valve 802 operates similar to the compensating valves 502, 702 of FIGS. 5 and 7 to improve the metered accuracy of the fuel flow through the FMV 208. For example, as shown in FIG. 8, a first hydraulic pressure line 804 is fluidly coupled between the third fluid line 218 and the compensating valve 802, and a second hydraulic pressure line 806 is coupled between the fourth fluid line 220 and the compensating valve 802. As such, the compensating valve 802 can sense or measure the pressure differential across the FMV 208. A third hydraulic pressure line 808 is fluidly coupled between the compensating valve 802 and the servo valve 252 of the actuator 236. Based on the measured pressure differential, the compensating valve 802 can adjust the pressure in the third hydraulic pressure line 808, which adjusts a force margin on the servo valve 252. Therefore, the actuator 236 can sense or measure the pressure differential across the FMV 208 and control the stroke of the variable displacement pump 206 to control the discharge flow rate and/or pressure. The compensating valve 802 improves the accuracy of the metering system by compensating for pressure droop across the servo valve 252. In particular, the compensating valve 802 improves the variation around the nominal pressure value so that the metered fuel out to the combustion section 118 is more accurate.

The controller 238 can operate substantially the same as disclosed in connection with the first fuel system 200 to operate the devices of the sixth fuel system 800 and control the flow rate and/or pressure of the fuel. In FIG. 8, the sixth fuel system 800 does not provide pressurized fuel to the actuator(s) 224 (FIG. 2). However, in other examples, the sixth fuel system 800 can provide pressurized fuel to the actuator(s) 224 similar to the first fuel system 200 in FIG. 2.

While an example manner of implementing the controller 238 is illustrated in FIGS. 2, 4, 5, 6, 7, and 8, one or more of the elements, processes, and/or devices illustrated in FIGS. 2, 4, 5, 6, 7, and 8 may be combined, divided, re-arranged, omitted, eliminated, and/or implemented in any other way. Further, the example input/output module 240, the example comparator 242, the example FMV controller 244, the example pump actuator controller 246, the example bypass valve controller 248, and/or, more generally, the example controller 238 of FIGS. 2, 4, 5, 6, 7, and 8, may be implemented by hardware alone or by hardware in combination with software and/or firmware. Thus, for example, any the example input/output module 240, the example comparator 242, the example FMV controller 244, the example pump actuator controller 246, the example bypass valve controller 248, and/or, more generally, the example controller 238, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controller 238 of FIGS. 2, 4, 5, 6, 7, and 8 may include one or more elements, processes, and/or devices in addition to, or instead of, those illustrated in FIGS. 2, 4, 5, 6, 7, and 8 and/or may include more than one of any or all of the illustrated elements, processes and devices.

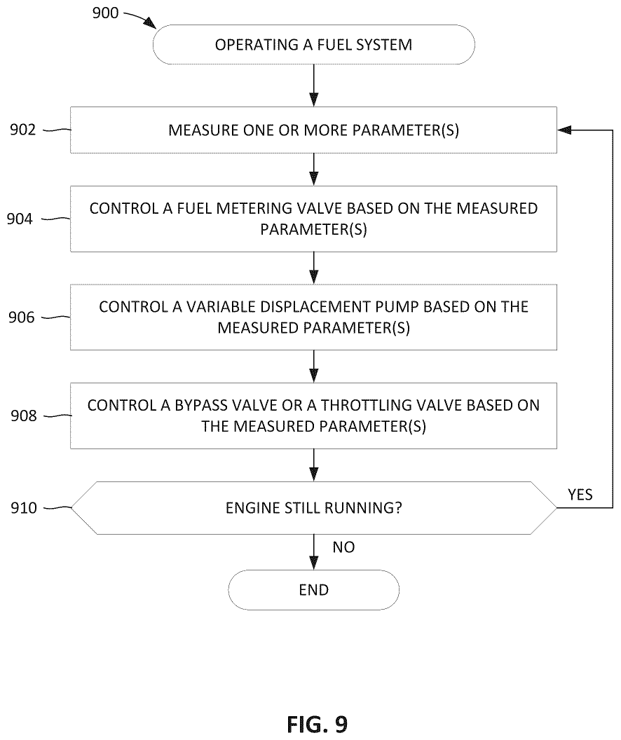

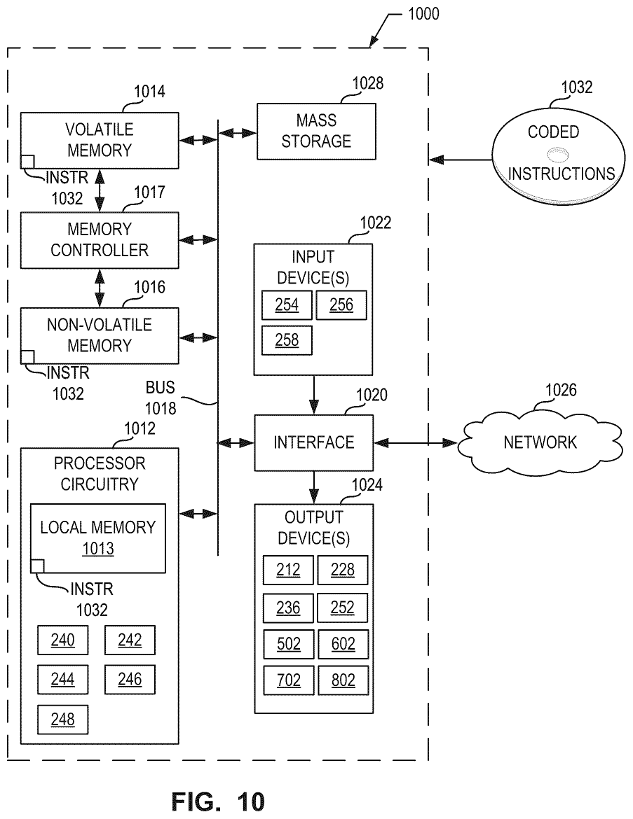

A flowchart representative of example machine readable instructions, which may be executed by programmable circuitry to implement and/or instantiate the controller 238 of FIGS. 2, 4, 5, 6, 7, and 8, and/or representative of example operations which may be performed by programmable circuitry to implement and/or instantiate the controller 238 of FIGS. 2, 4, 5, 6, 7, and 8, is shown in FIG. 9. The machine readable instructions may be one or more executable programs or portion(s) of one or more executable programs for execution by programmable circuitry such as the programmable circuitry 1012 shown in the example processor platform 1100 discussed below in connection with FIG. 10 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk.

The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums.

Further, although the example program is described with reference to the flowchart(s) illustrated in FIG. 9, many other methods of implementing the example controller 238 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.).

The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information).

As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed and/or instantiated by programmable circuitry for operating a fuel system. The example machine readable instructions and/or example operations 900 can be implemented in connection with any of the fuel systems 200, 400, 500, 600, 700, 800 disclosed herein.

At block 902, the controller 238 measures one or more parameter(s), such as temperature, pressure, speed, etc. For example, the input/output module 240 can receive signals from one or more sensors, such as the sensors 254, 256, 258. In some examples, the comparator 242 compares the measured parameter(s) to one or more thresholds.

At block 904, the FMV controller 244 controls the FMV 208 based on the measured parameter(s). Additionally or alternatively, the input/output module 240 can receive input signals (e.g., commands) from one or more other devices, such as pilot control devices (e.g., a thrust lever), and the FMV controller 244 can control the FMV 208 based on the input signals.

At block 906, the pump actuator controller 246 controls the variable displacement pump 206 based on the measured parameter(s). For example, the pump actuator controller 246 can control the actuator 236 to adjust the stroke length of the variable displacement pump 206, which affects the discharge flow rate and/or pressure of the variable displacement pump 206. In some examples, the pump actuator controller 246 controls the actuator 236 based on an outlet pressure the FMV 208 or pressure differential across the FMV 208. Additionally or alternatively, the pump actuator controller 246 can control the actuator 236 to achieve (e.g., operate at or near) a target pump discharge flow rate set by a Full Authority Digital Engine Control (FADEC).

At block 908, the bypass valve controller 248 controls the bypass valve 228 or the throttling valve 602 based on the measured parameter(s). For example, the bypass valve controller 248 may control the bypass valve 228 or the throttling valve 602 based on an outlet pressure the FMV 208 or pressure differential across the FMV 208.

At block 910, the controller 238 determines if the turbo engine 100 is still running. If the turbo engine 100 is not running (e.g., the turbo engine 100 has been shutdown), the example process of FIG. 9 ends. However, if the turbo engine 100 is still running, control proceeds back to block 1002 and the example process is repeated. This process may be repeated at a relatively high frequency. In particular, the controller 238 may be constantly monitoring the sensed parameter(s) and adjusting the various devices of the fuel system.

FIG. 10 is a block diagram of an example programmable circuitry platform 1000 structured to execute and/or instantiate the example machine-readable instructions and/or the example operations of FIG. 9 to implement the controller 238 of FIGS. 2, 4, 5, 6, 7, and 8. The programmable circuitry platform 1000 can be, for example, an electronic engine controller (EEC), a full authority digital engine control (FADEC), a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the input/output module 240, the comparator 242, the FMV controller 244, the pump actuator controller 246, and the bypass valve controller 248 of the example controller 238.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by the sensors 254, 256, 258. Additionally or alternatively, the input device(s) 1022 can be implemented by, for example, a pilot control device, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can include the servo valve 212 of the FMV 208, the bypass valve 228, the actuator 236, the servo valve 252, the compensating valve 502, the throttling valve 602, the compensating valve 702, and/or the compensating valve 802. Additionally or alternatively, the output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIG. 9 may be stored in the mass storage device 1028, in the volatile memory 1014, in the non-volatile memory 1016, and/or on at least one non-transitory computer readable storage medium such as a CD or DVD which may be removable.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

It can be appreciated that example fuel systems have been disclosed herein that utilize a variable displacement pump to enable adjustability of the discharge flow rate and/or pressure of the pump independent of the turbo engine speed. This enables the pump to operate at lower levels to reduce (e.g., minimize) excess fuel flow. This also reduces or limits the amount of waste heat that would otherwise be added to the fuel by a fixed displacement pump that over-produces pressurized fuel. Reducing or limiting the added heat reduces or eliminates the drawbacks of added heat described herein, such as fuel lacquering or coke formation.

Further examples and example combinations thereof are provided by the subject matter of the following clauses:

A turbo engine for an aircraft, the turbo engine comprising: a gas turbine engine having a combustion section; and a fuel system to provide fuel to the combustion section. The fuel system includes a variable displacement pump driven by an accessory gearbox that is powered by a shaft of the gas turbine engine. The variable displacement pump has an inlet side and an outlet side. The variable displacement pump includes an actuator configured to adjust a discharge flow rate of the variable displacement pump. The fuel system also includes a fuel metering valve configured to receive pressurized fuel from the variable displacement pump and control a flow rate of the pressurized fuel to the combustion section, and a bypass valve fluidly coupling the outlet side and the inlet side of the variable displacement pump to direct an excess portion of the pressurized fuel at the outlet side back to the inlet side.

The turbo engine of any preceding clause, wherein the variable displacement pump is a variable displacement vane pump or a variable displacement piston pump.

The turbo engine of any preceding clause, wherein the actuator is configured to adjust the discharge flow rate of the variable displacement pump based on an outlet pressure of the fuel metering valve.

The turbo engine of any preceding clause, wherein the fuel system further includes a controller to operate the actuator to achieve a target pump discharge flow rate.

The turbo engine of any preceding clause, wherein the target pump discharge flow rate is set by a Full Authority Digital Engine Control (FADEC).

The turbo engine of any preceding clause, wherein the actuator includes a servo valve, and wherein the servo valve is fluidly coupled to the inlet side and the outlet side of the variable displacement pump.

The turbo engine of any preceding clause, wherein the bypass valve is configured to control an amount of the pressurized fuel directed from the outlet side to the inlet side based on a pressure differential across the fuel metering valve.

The turbo engine of any preceding clause, wherein the fuel system includes a hydraulic pressure line that fluidly couples the bypass valve and an outlet side of the fuel metering valve.

The turbo engine of any preceding clause, wherein the fuel system includes a compensating valve configured to adjust a force margin on the bypass valve based on the pressure differential across the fuel metering valve.

The turbo engine of any preceding clause, wherein the fuel system includes a controller configured to operate the bypass valve based on a pressure differential across the fuel metering valve.

The turbo engine of any preceding clause, wherein the fuel system includes a boost pump upstream of the variable displacement pump.

The turbo engine of any preceding clause, wherein the boost pump is configured to be driven by the accessory gearbox.

A turbo engine for an aircraft, the turbo engine comprising: a gas turbine engine having a combustion section; and a fuel system to provide fuel to the combustion section. The fuel system includes a variable displacement pump driven by an accessory gearbox that is powered by a shaft of the turbo engine. The variable displacement pump includes an actuator configured to adjust a discharge flow rate of the variable displacement pump. The fuel system also includes a fuel metering valve configured to receive pressurized fuel from the variable displacement pump; and a throttling valve positioned between the fuel metering valve and the combustion section of the gas turbine engine. The throttling valve configured to reduce a pressure of the pressurized fuel to the combustion section.

The turbo engine of any preceding clause, wherein the throttling valve is configured to control an amount of the pressurized fuel directed from the outlet side to the inlet side based on a pressure differential across the fuel metering valve.

The turbo engine of any preceding clause, wherein the fuel system includes a hydraulic pressure line that fluidly couples the throttling valve and an inlet side of the fuel metering valve.

The turbo engine of any preceding clause, wherein the fuel system includes a compensating valve configured to adjust a force margin on the throttling valve based on the pressure differential across the fuel metering valve.

The turbo engine of any preceding clause, wherein the variable displacement pump is a variable displacement vane pump or a variable displacement piston pump.

A non-transitory machine readable storage medium comprising instructions that, when executed, cause programmable circuitry to measure a parameter of a fuel system for a gas turbine engine. The fuel system includes a variable displacement pump driven by an accessory gearbox that is powered by a shaft of the gas turbine engine, the variable displacement pump including an actuator configured to adjust a discharge flow rate of the variable displacement pump; a fuel metering valve configured to receive pressurized fuel from the variable displacement pump, the fuel metering valve to control a flow rate of the pressurized fuel to a combustion section of the gas turbine engine; and a bypass valve fluidly coupling an outlet side of the variable displacement pump and an inlet side of the variable displacement pump to direct an excess portion of the pressurized fuel at the outlet side back to the inlet side. The instruction further cause the programmable circuitry to control the variable displacement pump based on the measured parameter.

The non-transitory machine readable storage medium of any preceding clause, wherein the measured parameter is an outlet pressure of the fuel metering valve.

The non-transitory machine readable storage medium of any preceding clause, wherein the instructions, when executed, cause the programmable circuitry to control the bypass valve based on a pressure differential across the fuel metering valve.

A turbo engine for an aircraft, the turbo engine comprising: a gas turbine engine having a combustion section; and a fuel system to provide fuel to the combustion section. The fuel system includes a variable displacement pump driven by an accessory gearbox that is powered by a shaft of the turbo engine. The variable displacement pump includes an actuator to adjust a discharge flow rate of the variable displacement pump. The actuator including a servo valve. The fuel system also includes a fuel metering valve to receive pressurized fuel from the variable displacement pump. The fuel system including a compensating valve to adjust a force margin on the servo valve based on a pressure differential across the fuel metering valve.

A method comprising: measuring a parameter of a fuel system for a gas turbine engine. The fuel system includes a variable displacement pump driven by an accessory gearbox that is powered by a shaft of the gas turbine engine, the variable displacement pump including an actuator to adjust a discharge flow rate of the variable displacement pump, and a fuel metering valve to receive pressurized fuel from the variable displacement pump, the fuel metering valve to control a flow rate of the pressurized fuel to a combustion section of the gas turbine engine. The method further includes controlling the fuel metering valve based on the measured parameter, controlling the variable displacement pump based on the measure parameter, and controlling a bypass valve or a throttling valve based on the measured parameter.

The method of any preceding clause, further including determining if the gas turbine engine is still running.

The method of any preceding clause, wherein the measured parameter is an outlet pressure of the fuel metering valve. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A turbo engine for an aircraft, the turbo engine comprising:
a gas turbine engine having a combustion section; and
a fuel system to provide fuel to the combustion section, the fuel system including:
a boost pump;
a variable displacement pump having an inlet side and an outlet side, the inlet side fluidly coupled to the boost pump by a first fluid line, the variable displacement pump driven by an accessory gearbox that is powered by a shaft of the gas turbine engine, the variable displacement pump including an actuator configured to adjust a discharge flow rate of the variable displacement pump;
a fuel metering valve fluidly coupled to the outlet side of the variable displacement pump by a second fluid line, the fuel metering valve configured to receive pressurized fuel from the variable displacement pump and control a flow rate of the pressurized fuel to the combustion section, the fuel metering valve fluidly coupled to the combustion section by a third fluid line; and
one bypass valve, the bypass valve fluidly coupling the outlet side of the variable displacement pump and the first fluid line to direct an excess portion of the pressurized fuel at the outlet side back to the inlet side of the variable displacement pump;
a compensating valve;
a first hydraulic pressure line that fluidly couples the second fluid line and the compensating valve;
a second hydraulic pressure line that fluidly couples the third fluid line and the compensating valve; and
a third hydraulic pressure line that fluidly couples the compensating valve and the bypass valve, wherein the compensating valve is configured to adjust a force margin on the bypass valve, via the third hydraulic pressure line, based on the pressure differential across the fuel metering valve as measured via the first and second hydraulic pressure lines.

2. The turbo engine of claim 1, wherein the variable displacement pump is a variable displacement vane pump or a variable displacement piston pump.

3. The turbo engine of claim 1, wherein the actuator is configured to adjust the discharge flow rate of the variable displacement pump based on an outlet pressure of the fuel metering valve.

4. The turbo engine of claim 1, wherein the fuel system further includes a controller to operate the actuator to achieve a target pump discharge flow rate.

5. The turbo engine of claim 4, wherein the target pump discharge flow rate is set by a Full Authority Digital Engine Control (FADEC).

6. The turbo engine of claim 1, wherein the actuator includes a servo valve, and wherein the servo valve is fluidly coupled to the inlet side and the outlet side of the variable displacement pump.

7-11. (canceled)

12. The turbo engine of claim 1, wherein the boost pump is configured to be driven by the accessory gearbox.

13-20. (canceled)

21. The turbo engine of claim 1, wherein the fuel system further includes:
one or more hydraulically-powered actuators; and
a fourth fluid line that fluidly couples the second fluid line to the one or more hydraulically-powered actuators such that at least a portion of the pressurized fuel produced by the variable displacement pump is directed to the one or more hydraulically-powered actuators, and the fourth fluid line is fluidly coupled to the first fluid line to recirculate the pressurized fuel back to the inlet side of the variable displacement pump.

22. The turbo engine of claim 21, wherein the one or more hydraulically-powered actuators include an actuator for inlet guide vanes on the turbo engine.

23. The turbo engine of claim 21, wherein the one or more hydraulically-powered actuators include an actuator for a variable area exhaust on the turbo engine.

24. The turbo engine of claim 21, wherein the one or more hydraulically-powered actuators include at least one of a solenoid or a valve.

25. A turbo engine for an aircraft, the turbo engine comprising:
a gas turbine engine having a combustion section; and
a fuel system to provide fuel to the combustion section, the fuel system including:
a boost pump;
a variable displacement pump having an inlet side and an outlet side, the inlet side fluidly coupled to the boost pump by a first fluid line, the variable displacement pump, the variable displacement pump driven by an accessory gearbox that is powered by a shaft of the gas turbine engine;
a fuel metering valve fluidly coupled to the outlet side of the variable displacement pump by a second fluid line, the fuel metering valve configured to receive pressurized fuel from the variable displacement pump and control a flow rate of the pressurized fuel to the combustion section;
a bypass valve fluidly coupling the outlet side and the inlet side of the variable displacement pump to direct an excess portion of the pressurized fuel at the outlet side back to the inlet side; and
one or more hydraulically-powered actuators; and
a third fluid line that fluidly couples the second fluid line to the one or more hydraulically-powered actuators such that at least a portion of the pressurized fuel produced by the variable displacement pump is directed to the one or more hydraulically-powered actuators, and the third fluid line is fluidly coupled to the first fluid line to recirculate the pressurized fuel back to the inlet side of the variable displacement pump.

26. The turbo engine of claim 25, wherein the one or more hydraulically-powered actuators include an actuator for inlet guide vanes on the turbo engine.

27. The turbo engine of claim 25, wherein the one or more hydraulically-powered actuators include an actuator for a variable area exhaust on the turbo engine.

28. The turbo engine of claim 25, wherein the one or more hydraulically-powered actuators include at least one of a solenoid or a valve.
